(19) United States
(12) Patent Application Publication
(10) Pub. No.: US 2019/0295428 A1
(43) Pub. Date: Sep. 26, 2019

(54) UASTrakker - Emergency RF locator for drones and robots

(71) Applicant: Harlan Shawn Holmgren, Lake City, FL (US)

(72) Inventor: Harlan Shawn Holmgren, Lake City, FL (US)

(21) Appl. No.: 16/501,286

(22) Filed: Mar. 18, 2019

Related U.S. Application Data
(60) Provisional application No. 62/646,345, filed on Mar. 21, 2018.

(51) Int. Cl. G08G 5/00; G01S 5/02; G01S 5/10; B64C 39/02

(52) U.S. Cl. CPC G08G 5/0069; G08G 5/0013; G08G 5/0039; B64C 2201/141; G01S 5/10; B64C 39/024; G01S 5/0284

(57) ABSTRACT

Systems and methods for autonomous location of RF devices; providing navigation and dispatch between robotic systems or unmanned aerial vehicles, and the target asset; whether a vehicle, person, animal or object. Tracking these assets may be done during an emergency event, and all other purposes that are legal, including monitoring vessels.

The method for navigating a robotic or airborne system relative to a target, comprises of detecting an Emergency Radio Frequency on the robotic device or unmanned vehicle, and/or the associated Ground Control Station (GCS), along with a Radio Frequency generated by a Radio on the target, such as AIS.

The system compares the detected Radio Frequency signals with previously-detected Radio Frequency signals, and adjusts the position of the robotic or airborne device based on the determined change in location, or a movement of the target based on information indicative of a position, an orientation, velocity, or altitude of the target.

### TECHNICAL FIELD

The present disclosure relates generally to unmanned aerial vehicles and, more particularly, to systems and methods for effectively and accurately navigating an unmanned aerial vehicle relative to a moving target, using Radio Frequency Locator Beacons.

### BACKGROUND

Robots and Unmanned Aerial Systems (“UASs”) are poised to change our society in ways that have yet to be imagined.

One of the key technologies enabling autonomous (as opposed to piloted) use of UASs is positioning and control. Conventionally, UAS designers have put emphasis on absolute positioning (the specific location or position of the UAS in a coordinate space), since it has generally been thought of as being instrumental to the success of the mid- to high-altitude intelligence, surveillance, and reconnaissance (“ISR”) missions where UASs have typically been used by the military (the primary user of UASs to date). With the proliferation of low-flying portable UASs (e.g. multi-rotors), however, reliable relative positioning is crucial. This will enable UASs to locate an asset or target while safely operating in close proximity to and relative to other (mobile) humans and machines, for both military and civilian applications.

First responders need systems that are even more autonomous than personal UASs. They generally cannot require every user to become a highly skilled remote-control pilot. In addition, these robotic systems should operate as autonomously as possible, in order to free the user to focus on the specific mission, instead of exclusively about operating the robot or UAS.

Before such First Responder robots and UASs can become a reality, they should generally be reliable and accurate in locating their target(s) using traditional emergency location devices. The target can be a person (walking, running, biking, skiing, swimming, hiking, etc.), an animal (military/search-and-rescue dog), another vehicle (a car, a truck, ATV, motorcycle or another robot or unmanned UAS), a moving or a stationary reference (landing pad, floating dock, military platform on ship or Airports, and or National park helipads.

Robotic and UAS positioning and control technologies typically focus on performing these tasks in the absolute frame, i.e., with respect to fixed coordinates. Developing Emergency Radio Frequency flight control, (Typically VHF), technology for military and First Responder UASs will be the focus of our work.

The presently disclosed relative navigation system addresses many of the problems and issues set forth above, thereby enabling UASs to be operated by personnel without exceptional piloting skills. As such, the presently disclosed system allows operators to simply designate where the UAS is to be positioned by embedding target Emergency Band radios on the object of interest. Accordingly, the presently disclosed systems and methods for effectively and accurately navigating an unmanned aerial vehicle relative to a moving target are directed to overcoming one or more of the problems set forth above and/or other problems in the art.

### SUMMARY

A system providing reliable, high-accuracy Emergency relative navigation for UASs is desirable. Systems and methods associated with the presently-disclosed embodiments enable small UASs to autonomously locate persons or assets through the use of PLBs or other Emergency RF communication devices, regardless of the operating and environmental conditions (urban, mountainous, day/night/weather, GPS (un)availability, LOS/NLOS). Systems and methods consistent with the disclosed embodiments take advantage of the mobility of the UAS, multiple sensors including Emergency Band RF Beacons, and advanced fusion and control algorithms to accurately resolve and control the position of the UAS relative to the target. This system is platform-agnostic and will be suitable to most medium sized UAS's, and emergency RF beacons currently available.

According to one embodiment, the UAS system generally consists of a so-called companion computer. located onboard the UAS, which may also contain a variety of other sensors, and processes their information in our navigation software. The companion computer can also leverage information from additional target devices, containing a suite of sensors and a data link to the UAS. At least one target device is required for the UASTrakker Pack to provide a full relative navigation solution.

The presently disclosed system provides the following key attributes to any small UAS: (A) autonomy: Requires little to no user input, so the user can focus on his task (“launch and forget”); and (B) availability: 1) Can be deployed and recovered automatically anywhere, even from moving vehicles, and 2) Functions in harsh operational environments (day/night/rain, etc.) for un-interrupted support to ground personnel in the real-world; (C) safety and reliability: it will locate people or moving assets, and can be trusted to work every time

The presently disclosed systems and methods address the navigation, guidance and control challenges by leveraging the collaborative and “locating” nature of this application. The collaborative relationship between the UAS and its target implies that the UAS may have access to both pre-configuration and real-time information about the target. This data is leveraged in multi-sensor/multi-platform fusion algorithms that make our system robust to both motion, relocation and environmental disturbances.

According to one aspect, the present disclosure is directed to a method for navigating an Unmanned Aerial System relative to a flight plan, in search of a target. The method may comprise detecting, using an Emergency Radio Frequency detector on the airborne device pack, an Emergency Radio Frequency signal generated by a commercially available Emergency transponder on the target. The method also comprises comparing, by a processor on the airborne device pack, the detected Radio Frequency signal with a previously-detected Radio Frequency signal. The method further comprises determining, by the processor based on the comparison, a change in location of at least one of the Unmanned Aerial System (UAS), Ground Control Station (GCS) or the target. The method also comprises adjusting a position of the UAS based on the determined change in location.

According to one aspect, the present disclosure is directed to a method for LTE, Cellular or Satellite back-up navigation of an airborne system relative to a flight plan, in search of a target, using RF Beacons. The method may comprise detecting, on an Emergency Radio Frequency detector on the UAS, an Emergency Radio Frequency signal generated by a commercially available Emergency transponder on the target. The method also comprises translating those signals into ASCII text data that is sent to a “Cloud Data Service”, by a modem on the airborne system. The translated Radio Frequency signal data will be compared with previously-detected Radio Frequency signal data in the “Cloud Data Service”. The method further comprises alerting the Operator of the Cloud Data Service, a change in location of at least one of the UAS, Ground Control Station (GCS) or the target. The method also comprises allowing the Operator of the Cloud Data Service to adjust the position of the UAS through the airborne device pack, transmitting that instruction to the aircraft via 2-way modem communication, (e.g. LTE, cellular, satellite, or other).

In accordance with another aspect, the present disclosure is directed to a system for persistent aerial monitoring of a target. The system comprises a target device coupled to a target, wherein the target device comprises at least one Transponder configured to generate a Radio Frequency signal. The system also comprises an airborne device pack coupled to an airborne vehicle and in data communication with the target device. The airborne device pack comprises a Radio Frequency detector configured to detect the Radio Frequency signal generated by the target device, and a processor communicatively coupled to the Radio Frequency detector. The processor may be configured to compare the detected Radio Frequency signal with a previously-detected Radio Frequency signal, determine a change in location of at least one of the airborne device pack or the target, and generate a control signal for adjusting a position of the airborne device pack based, at least in part, on the determined change in location.

In accordance with another aspect, the present disclosure is directed to a method for aerial tracking of a target. The method may comprise detecting, at a Radio Frequency detector associated with the airborne device pack, an Emergency Radio Frequency signal pattern generated by a transponder associated with the target, such as a commercially available Personal Locator Beacon, (PLB). The method may also comprise comparing, by a processor associated with the airborne device pack, the detected pattern with a previously-detected Radio Frequency pattern and with a baseline pattern. The method may further comprise determining, by the processor based on the comparison, a change in location of at least one of the UAS or the target. The method may also comprise receiving, at the processor associated with the airborne device pack from at least one sensor located on-board the target, information indicative of at least one of a position including latitude and longitude, a rotation, an orientation, an acceleration, a velocity, or an altitude associated with the target.

### BRIEF DESCRIPTION OF THE DRAWINGS

FIG. 1A illustrates one exemplary operation environment including a UAS and First Responder, in which the presently disclosed systems and methods for effectively and accurately navigating an unmanned aerial vehicle relative to an emergency moving target may be implemented, consistent with certain disclosed embodiments;

FIG. 1B illustrates another exemplary operation environment including a UAS and Emergency Target, in which the presently disclosed systems and methods for effectively and accurately navigating an unmanned aerial vehicle relative to a moving target, such as a Personal Locator Beacon (PLB) or man-over-board may be implemented, in accordance with certain disclosed embodiments;

FIG. 1C illustrates another exemplary operation environment including a UAS and its Ground Control Station, (GCS), in which the presently disclosed systems and methods for effectively and accurately navigating an unmanned aerial vehicle relative to a moving target may be implemented, in accordance with certain disclosed embodiments;

FIG. 2 illustrates an exemplary UASTrakker Emergency RF Tracking System, such as an unmanned aerial vehicle (UAS), in accordance with certain disclosed embodiments;

FIG. 3 provides a block diagram of exemplary components associated with a system for navigating an unmanned aerial vehicle relative to a moving target, in accordance with certain disclosed embodiments;

FIG. 4 illustrates a schematic diagram of a system in which the presently disclosed methods for navigating an unmanned aerial vehicle relative to a moving target, are described consistent with certain disclosed embodiments; and

FIG. 5 provides a flowchart depicting an exemplary process to be performed by one or more hardware and software processes controlling a system for navigating an unmanned aerial vehicle relative to a moving target, in accordance with certain disclosed embodiments.

### DETAILED DESCRIPTION

Systems and methods consistent with the disclosed embodiments are directed to solutions for tracking of a target object (whether mobile or stationary) by an airborne device pack, such as an unmanned aerial vehicle (UAS), or other system controlled by a robotic brain. More particularly, the processes and features disclosed herein provide a solution for allowing the unmanned aerial system, (or Robot), to accurately and reliably follow a target device, while maintaining a generally constant relative distance from the target device and avoiding obstacles in the path of the UAS or robot. Exemplary features associated with the presently disclosed system include path prediction schemes for adjusting the flight path of the UAS or robot during tracking of the target. One or more Radio Frequency devices mounted on the UAS or robot in the airborne device pack are used for tracking of the target, as well as cameras to record video of the target for various uses, such as security; intelligence, surveillance, and reconnaissance (ISR) activities, aerial search and recovery, and recreational use, all autonomously, without requiring advanced user piloting activities.

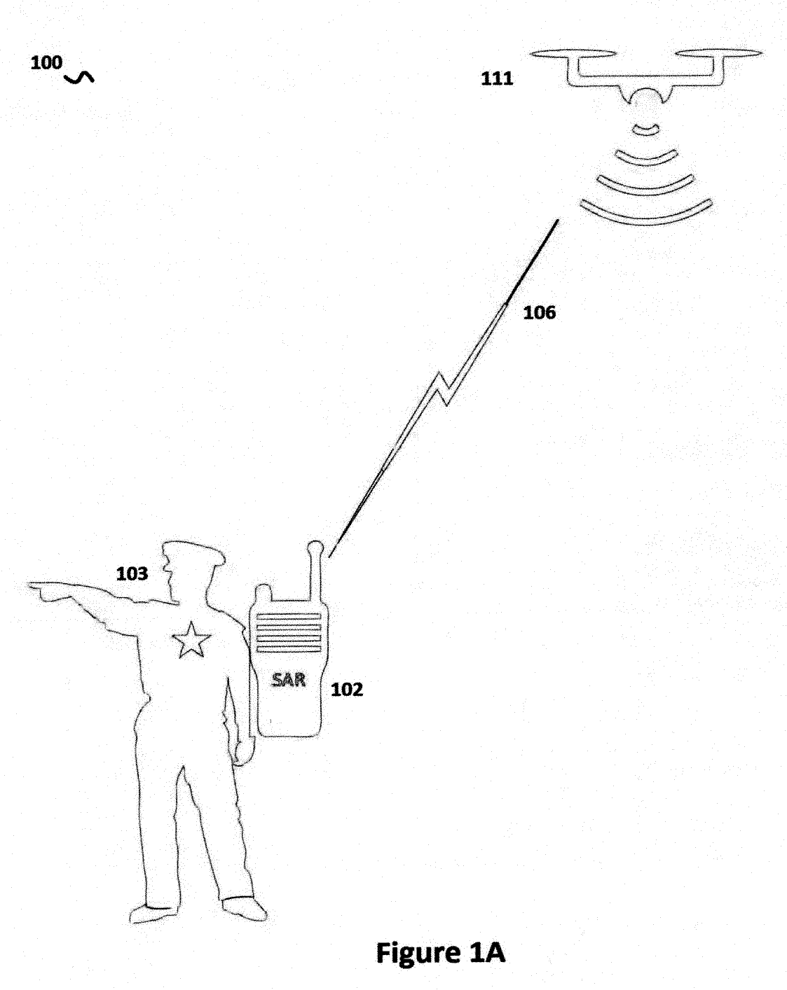

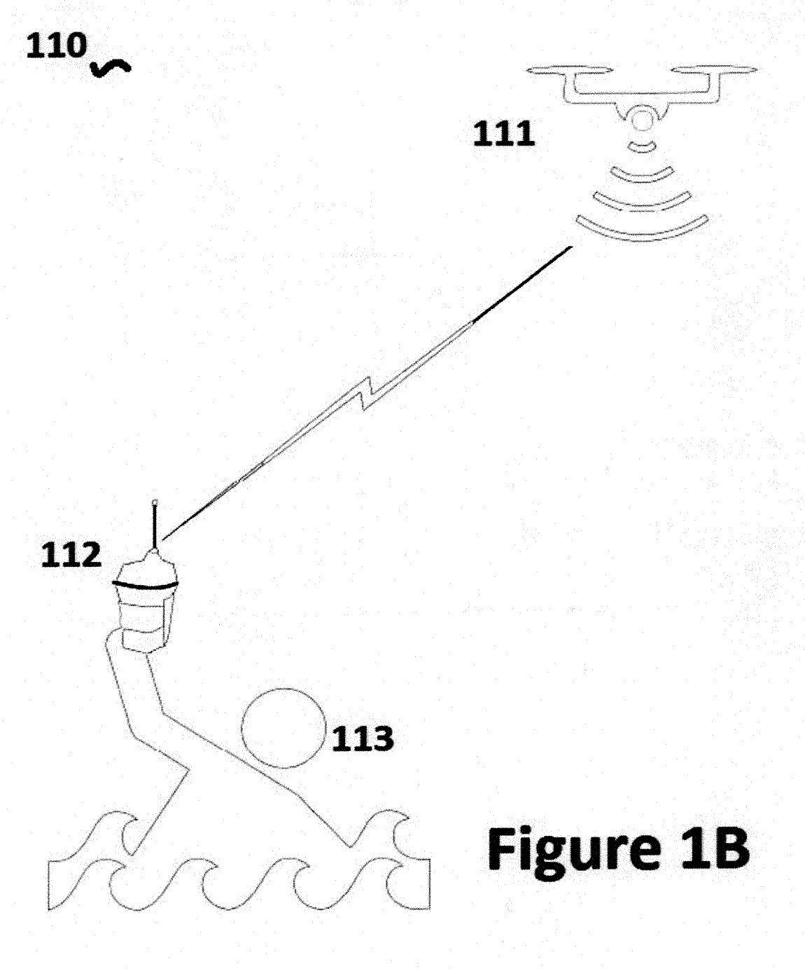

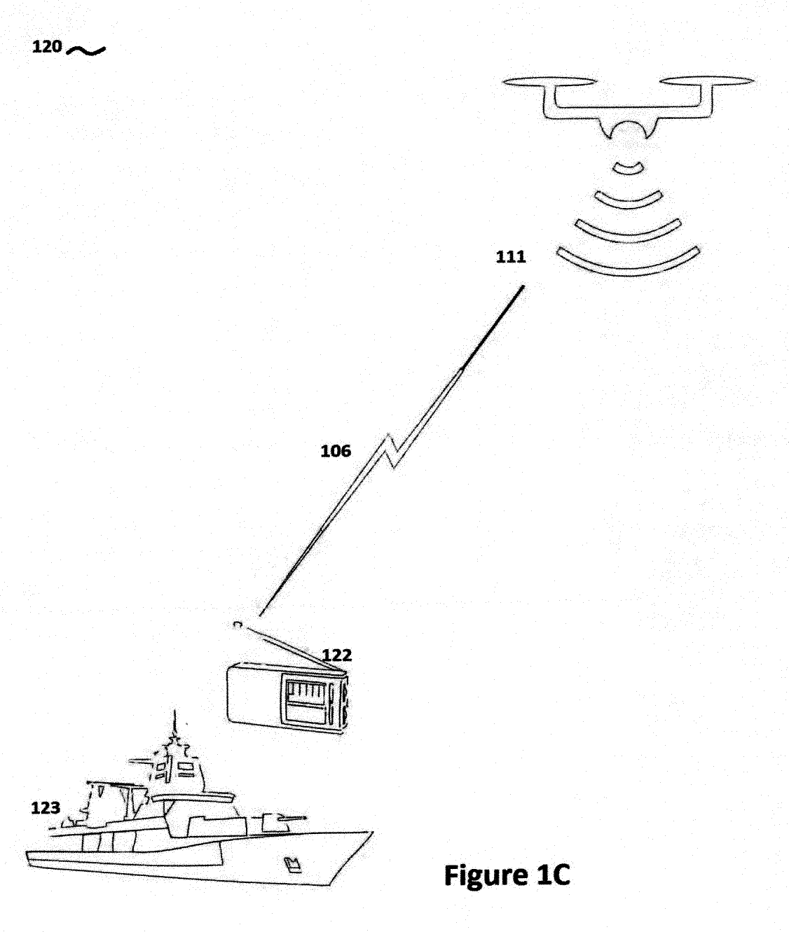

FIGS. 1A-1C illustrate exemplary operational environments 100, 110, and 120, respectively, in which the presently disclosed systems and methods for effectively and accurately navigating an unmanned aerial vehicle relative to a moving target may be implemented. As illustrated in each of FIGS. 1A-1B, according to exemplary embodiments, the operational environment 100, 110, 120 may include an airborne vehicle 111, such as an unmanned aerial vehicle (UAS) and one or more stationary or moving target objects 103. In certain embodiments, airborne vehicle 111 may be communicatively coupled via a data link 106 to one or more electronic components or target devices that may be mounted or otherwise coupled to target 103.

As illustrated in FIG. 1A and as will be explained in greater detail in connection with the figures and flowcharts that follow, airborne vehicle 111 may be configured to track target 102 from an aerial flight position along a predetermined flight path.

The presently disclosed system is designed to be integrated into existing UASs in order to transform them into personal UASs that are smarter and more autonomous.

As illustrated in FIG. 1B, the system generally comprises two parts;
a. The aircraft tracking RF devices (UASTrakker System) and
b. A target or user Emergency RF PLB type device 112.

The UASTrakker System Components are mounted on airborne vehicle 111 in a location that enables it to have an unobstructed radio view of target 113.

The target device 112 is mounted on the target 113 and is typically a VHF PLB (Personal Locator Beacon), {e.g. 121.5 MHz, 161.975 MHz (AIS1, or channel 87B) and 162.025 MHz (AIS2, or channel 88B), 406 MHz, etc.} but other wavelengths of Radio Frequency or satellite signals are contemplated to be distributed on the target 113.

As illustrated in FIG. 1C, the system generally comprises two parts;
c. The aircraft tracking RF devices (UASTrakker System) and
d. A target or user Emergency RF PLB type device 122.

The UASTrakker System Components are mounted onto a maritime vessel 123 in a location that enables it to have an unobstructed radio view of target 122.

The target device 122 is mounted on the target 123 and is typically a VHF PLB (Personal Locator Beacon), or commercial radio system {e.g. 121.5 MHz, 161.975 MHz (AIS1, or channel 87B) and 162.025 MHz (AIS2, or channel 88B), 406 MHz, etc.} but other wavelengths of Radio Frequency or satellite signals are contemplated to be distributed on the target 113.

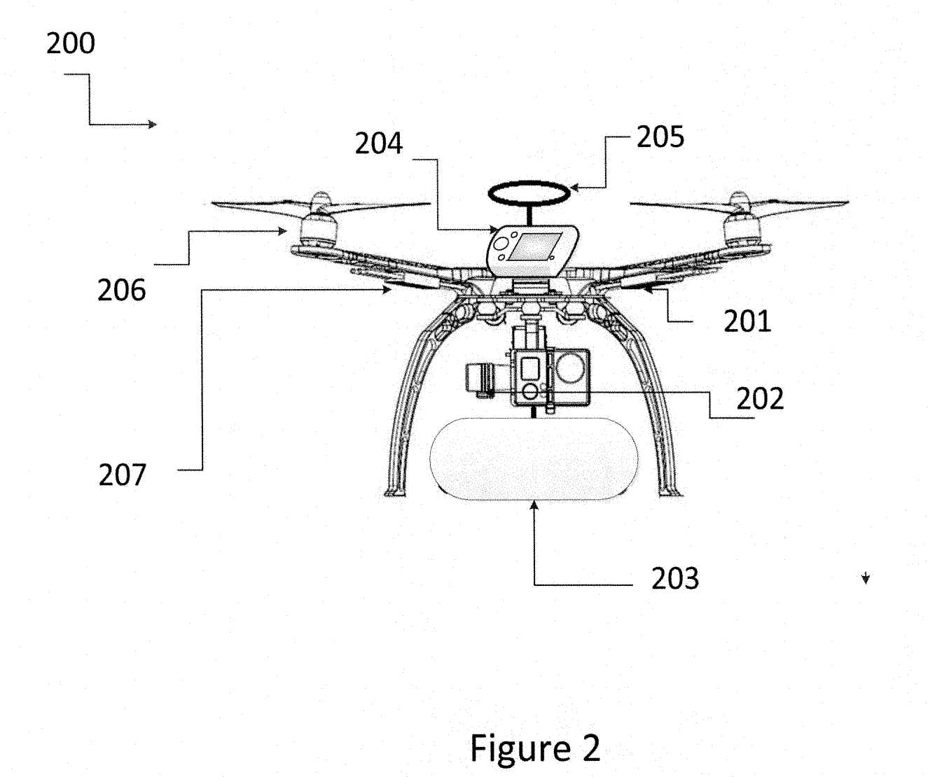

FIG. 2 illustrates a multi-rotor aerial vehicle 200 (e.g., a UAS), in accordance with certain disclosed embodiments. As illustrated in FIG. 2, the UAS may comprise one or more electrical components adapted to control various aspects of the operation of the UAS, which may be disposed inside a housing or cavity associated with the airborne device pack or mounted to the airborne device pack such as on the underside of the device. Such electrical components can include an energy source (e.g., battery), flight control or navigation module, GPS module (e.g., GPS receivers or transceivers), inertial measurement unit (IMU) module, communication module (e.g., wireless transceiver), electronic speed control (ESC) module 207 adapted to control an actuator (e.g., electric motor) 206, such as an electric motor used to actuate a rotor blade or rotor wing of the UAS, electrical wirings and connectors, and the like. In some embodiments, some of the electrical components may be located on an integrated electrical unit such as a circuit board or module. One or more electrical units may be positioned inside the housing of the Robot or airborne vehicle 201. When in use, the electrical components discussed herein may cause interference (e.g., electromagnetic interference) to other components 205 (e.g., magnetometer) of the UAS. In some embodiments, the interference may be caused by ferrous material or static sources of magnetism. For example, the electrical components may comprise magnets that generate magnetic fields, thereby causing magnetic interference.

As illustrated by FIG. 2, the body portion of the UAS 201 comprises a central housing member and one or more branch housing members. The inner surface of the central housing member can form a central cavity. Each of the branch housing members, in the shape of a hollow arm or any other suitable shape, can form a branch cavity. When the central housing member is connected to the one or more branch housing members, the central cavity and the one or more branch cavities can collectively form one unified cavity.

The branch housing members can be connected to the central housing member in an “X” or star shaped arrangement. Specifically, the central housing member can be located at the center of the X or star shaped arrangement whereas the branch housing members can be distributed around the central housing member, in a symmetric or asymmetric fashion. In some embodiments, such a star-shaped arrangement can facilitate efficient electrical connection between electrical components disposed within the cavity of the housing, such as between a centrally located flight control module and the individual ESC modules located in respective branch cavities. Or between a centrally located energy source (e.g., battery) and actuators (e.g., electric motors) used to drive the rotors of a multi-rotor UAS. In other embodiments, the housing and/or the cavity inside the housing of the UAS may have a shape other than the star shape described herein. For example, the housing and/or the cavity inside the housing can form a substantially spherical, elliptical, or cylindrical shape or any other shape.

In a typical embodiment, the number of branch housing members is equal to the number of rotors or actuator assemblies of the UAS. An actuator assembly (not shown) can include a rotor wing or rotor blade and an actuator that is used to actuate the rotor blade, for example, a four-rotor quadcopter such as illustrated in FIG. 2 may have four branch housing members, each corresponding to one of the four rotors or actuator assemblies. In the illustrated embodiment, the UAS has four branches, each corresponding to one actuator assembly. That is, the UAS has four actuator assemblies. In various embodiments, the number of the branches and/or the arrangement thereof may be different from those illustrated herein. For example, in some embodiments, there may be more or less branch housing members and/or rotors or actuator assemblies than illustrated here. For example, a 6-rotor UAS may have six rotors or actuator assemblies and six corresponding branch housing members. An 8-rotor UAS may have eight rotors or actuator assemblies and eight corresponding housing members. In alternative embodiments, the number of branch housing members may not correspond to the number of rotors or actuator assemblies of the UAS. For example, there may be more or less branch housing members than actuator assemblies. In various embodiments, the numbers of branches, actuator assemblies, and actuators can be adjusted according requirements of actual circumstances. To ensure stability of the UAS during operation, a typical multi-rotor UAS has no less than three rotors.

In various embodiments, the one or more electrical components may be adapted to control various aspects of the operation of the UAS. Such electrical components can include an energy source (e.g., battery), flight control or navigation module, GPS module (e.g., GPS receivers or transceivers), inertial measurement unit (IMU) module, communication module (e.g., wireless transceiver), electronic speed control (ESC) module adapted to control an actuator (e.g., electric motor), actuator such as an electric motor that is used to actuate a rotor blade or rotor wing of the UAS, connecting members configured to electrically connect the electrical components (such as electrical wirings and connectors), and the like. In various embodiments, some or all of the electrical components of the UAS may be located inside the housing.

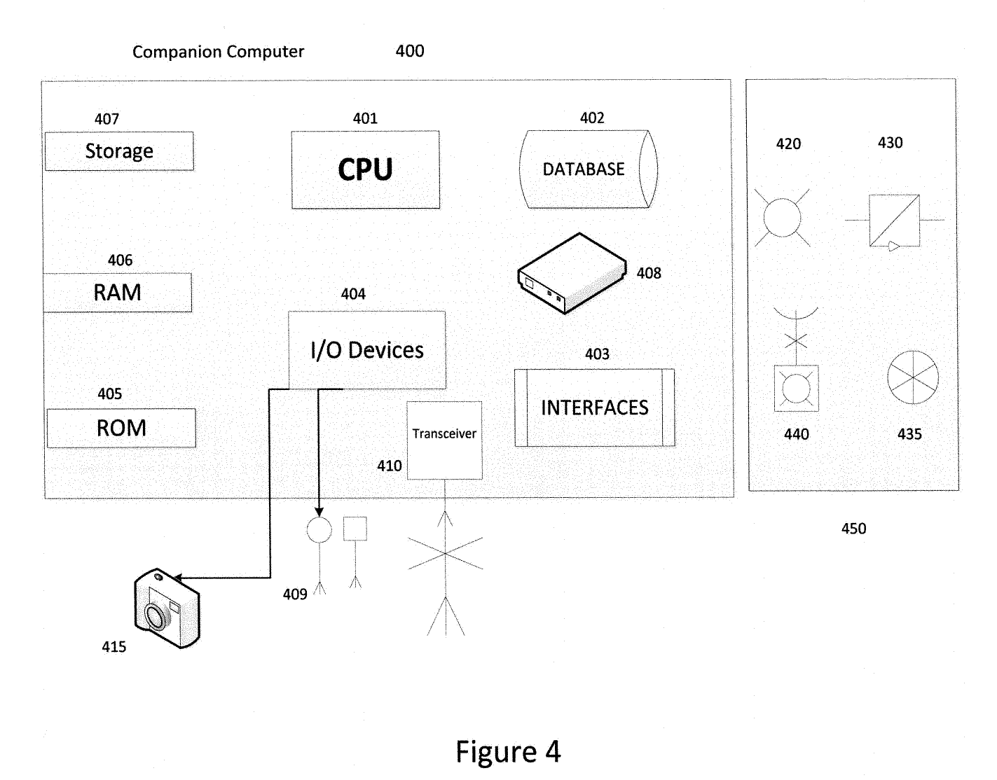

In some embodiments, some of the electrical components discussed above may be located on one or more circuit modules. Each circuit module can include one or more electrical components. For example, as shown in FIG. 4, the circuit module can include the main flight control module that includes one or more processors (such as implemented by a field-programmable gate array (FPGA)) for controlling key operations of the UAS. As another example, the same or a different circuit module can also include an IMU module for measuring the UAS's rotational rate, and acceleration. The IMU module can include one or more accelerometers and/or gyroscopes. As another example, the same or a different circuit module can also include a communication module for remotely communicating with a target device. For example, the communication module can include an Emergency VHF transceiver.

The flight control module, or processor, is typically a key component or “brain” of an UAS. For example, the flight control module can be configured to estimate the current velocity, orientation and/or position of the UAS based on data obtained from onboard sensors like a compass, IMU, GPS receiver and/or other sensors, perform path planning, provide control signals to actuators to implement navigational control, and the like. As another example, the flight control module can be configured to issue control signals to adjust the state of the UAS based on remotely received control signals.

In some embodiments, the electrical components can include one or more electronic speed control (ESC) modules. An ESC module can be adapted to control the operation of an actuator. The actuator can be part of an actuator assembly and configured to actuator a rotor blade or wing of the UAS. In some embodiments, the ESC module can be electrically connected to the flight control module on the one hand, and an actuator on the other hand. The flight control module can provide control signals for the ESC module, which in turn provides actuator signals to the electrically connected actuator so as to actuate the corresponding rotor blade. In some embodiments, feedback signals can also be provided by the actuator and/or the ESC module to the flight control module.

In some embodiments, the UAS also includes one or more connecting members for electrically coupling or connecting the various electrical components of the UAS. Such connecting members can include electrical wires, cables, and the like that are used for transmitting power, data or control signals between the components. For example, the connecting members can be used to electrically connect 1) an energy source and an actuator assembly; 2) a circuit module and an ESC module; 3) an ESC module and an actuator; 4) a communication module and a circuit module, or the like. In some embodiments, the connecting members have pluggable connectors at the distal portions to facilitate plugging and unplugging of the connecting members with respect to the electrical components.

In some embodiments, some or all of the electrical components discussed above are preconfigured, pre-assembled or pre-connected by a manufacturer of the UAS. In such embodiments, no or very little user assembly and/or calibrate may be required for the UAS to operate, making the UAS “ready-to-fly” out-of-the-box. Such pre-configuration of components not only enhances the user experience by lowering the technical expertise required, but also reduces the errors or accidents caused by user misconfiguration. In some embodiments, such pre-configured or pre-assembled components can include the flight control module, GPS receiver, ESC module, or any of the electrical components discussed herein, or any combination thereof. In some embodiments, one or more electrical components may be pre-configured, pre-connected or pre-assembled as an electrical unit (e.g., a circuit module). The electrical unit may be necessary and sufficient for controlling operation of the UAS. In some embodiments, no additional user configuration is required for the pre-configured components to operate properly out-of-the-box. In other embodiments, some amount of user configuration or assembly may be required. In other situations, the user may define certain parameters, such as flight height and range between the Robot or airborne vehicle 111 and target 113 from a plurality of pre-selected parameters.

### System Configuration

FIG. 2 illustrates an exemplary embodiment of devices that are used in the presently disclosed systems for effectively and accurately navigating an unmanned aerial vehicle relative to a moving target.

Processing hardware 204 associated with airborne vehicle 200 may include or embody any suitable microprocessor-based device configured to process and/or analyze information collected by sensors associated with the respective system.

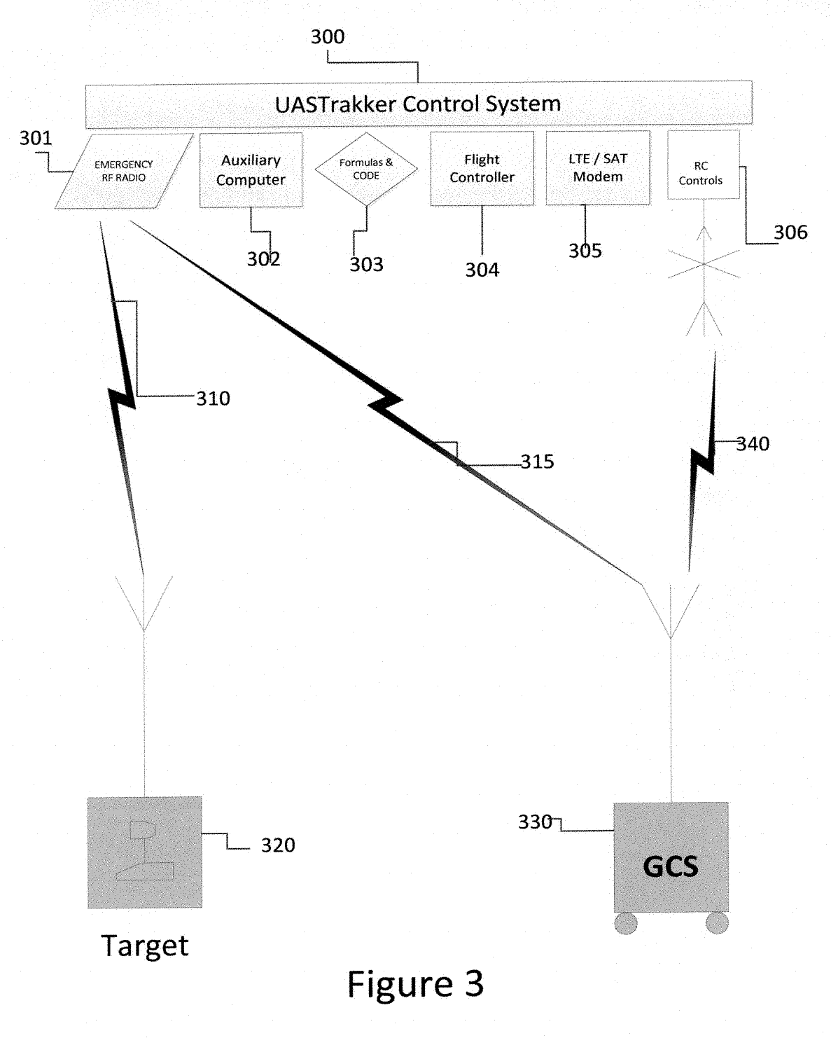

FIG. 3 illustrates an exemplary embodiment of components that are used in the presently disclosed systems Airborne Device Pack (UASTrakker System) 300 for effectively and accurately navigating an unmanned aerial vehicle relative to a moving target 320, by use of an Emergency RF Transceiver 301.

According to one embodiment, the Airborne Device Pack (UASTrakker System) 300 may embody a general-purpose computer programmed with software for receiving and processing RF Signals, for example, position information associated with the corresponding component of the system.

According to other embodiments, processing hardware 302 may be a special-purpose computer or ASIC to perform specific processing tasks (e.g., ranging, path prediction, obstacle detection, or collision avoidance). Individual components of, and processes/methods performed by written formulas and code 303, flight controller 304 controls the UAS, 305 gives the UAS connectivity and 306 is the RC Controls for manually guiding the UAS.

FIG. 3 illustrates an exemplary embodiment of RF Radio suite that is used in the presently disclosed systems for effectively and accurately navigating an unmanned aerial vehicle relative to a moving target 320. GCS 330 uses traditional radio waves 315 for UAS hand controls 340, and Emergency Band RF for Rescue Operation signals 315. Target 320 uses a PLB or other Emergency transceiver to transmit its location 310. Aircraft picks up both locations using its onboard Emergency RF Transceiver 301.

According to the embodiment illustrated in FIG. 3, both the airborne device pack 300 and target device 320 have one or more inertial measurement units (IMUs), static pressure sensors, tri-axial magnetometers, and/or GPS transceivers.

As illustrated in FIG. 4 airborne vehicle may also include one or more Emergency RF Radios or Transceivers 410, each of which is configured to detect Radio Frequency signal emitted by a PLB that is associated with target. The embodied Robot or Airborne vehicle may also include one or more range sensors 418, 420 configured to detect the range sensors that are configured to detect the relative distance between the Robot or airborne vehicle and target device. Raw data from all sensors may be provided to the UASTrakker proprietary “code processing module”, where it can be fused to estimate the relative state, and compute guidance commands that are then sent to the autopilot (pitch, roll, yaw, thrust).

As illustrated in FIG. 1C Airborne vehicle may be communicatively coupled to a target device and may be configured to receive, process, and/or analyze data measured by the target device 122. According to one embodiment, airborne vehicle 111 may be wirelessly coupled to target 123 via respective wireless communication transceiver(s) 122 operating any suitable protocol for supporting wireless (e.g., Emergency Band, Wi-Fi, etc.)

Wireless communication transceiver(s) 122, associated with airborne vehicle 111 and target device 123, respectively, may include any device suitable for supporting wireless communication between one or more components of airborne vehicle 111 and target device 112. As explained above, wireless communication transceiver(s) 122 may be configured for operation according to any number of suitable protocols for supporting wireless communication protocols or standards. According to one embodiment, wireless communication transceiver 122 may embody a standalone communication module, separate from the respective Companion Computer systems. As such, wireless communication transceiver 122 may be electrically coupled to the respective Companion Computer system of airborne device pack 111 or target 123 via Cellular or other data communication link and configured to deliver data received therein to the corresponding Companion Computer system for further processing/analysis. According to other embodiments, wireless communication transceivers 122 may embody an integrated wireless transceiver chipset, such as the Emergency Band RF, Bluetooth, Wi-Fi, NFC, or 802.11x wireless chipset included as part of the respective processor of airborne vehicle 111 or target device 112.

### Radio & Sensor Fusion

FIG. 4 illustrates a schematic diagram of a Companion Computer system 400, in which the presently disclosed methods for navigating an unmanned aerial vehicle relative to a moving target will take place, consistent with certain disclosed embodiments. This Companion Computer system may be included as part of airborne vehicle or target device, and may include additional and/or different computer components than those illustrated in FIG. 4. For example, database 402, storage 407 and modem 408 may be omitted from the target device in order to reduce size, weight, and cost of the device. Essentially, FIG. 4 serves to illustrate the exemplary (and optional) hardware that may be used in performing the data processing and analysis that is generally associated with the airborne device pack. It should be understood, however, that, given the collaborative nature of the system, some or all of these components may be included as part of target device, as well.

As explained, the Companion Computer system 400, associated with airborne vehicle (and, optionally, target device) may be any processor-based computing system that is configured to receive sensor information from the Emergency Radio Transponder and/or core sensor package 450, calculate the relative position of one or more of the airborne device packs or target device, analyze the relative position information, and adjust the position of the Robot or airborne vehicle in order to track the target and maintain a relative distance between the Robot or airborne vehicle and target. Nonlimiting examples of such a Companion Computer system may include a desktop or notebook computer, a tablet device, a smartphone, wearable or handheld computers, ASIC, or any other suitable processor-based computing system. As illustrated in FIG. 4, core sensor package 450 may include GPS 420, IMU 430, barometer 435, magnetometer 440, and range sensor 409.

For example, as illustrated in FIG. 4, Companion Computer system may include one or more hardware and/or software components configured to execute software programs, such as range finding, collision avoidance, obstacle detection, path planning, just to name a few. According to one embodiment, Companion Computer system may include one or more hardware components such as, for example, a central processing unit (CPU) or microprocessor 401, a random-access memory (RAM) module 406, a read-only memory (ROM) module 405, a memory or data storage module 407, a database 402, one or more input/output (I/O) devices 404, and an interface 403. Alternatively, and/or additionally, Companion Computer system may include one or more software media components such as, for example, a computer-readable medium including computer executable instructions for performing methods consistent with certain disclosed embodiments. It is contemplated that one or more of the hardware components listed above may be implemented using software. For example, storage 407 may include a software partition associated with one or more other hardware components of Companion Computer system. Processing system may include additional, fewer, and/or different components than those listed above. It is understood that the components listed above are exemplary only and not intended to be limiting.

CPU 401 may include one or more processors, each configured to execute instructions and process data to perform one or more functions associated with Companion Computer system 400. As illustrated in FIG. 4, CPU 401 may be communicatively coupled to RAM 406, ROM 405, storage 407, database 402, I/O devices 404, and interface 403. CPU 401 may be configured to execute sequences of computer program instructions to perform various processes, which will be described in detail below. The computer program instructions may be loaded into RAM 406 for execution by CPU 401.

RAM 406 and ROM 405 may each include one or more devices for storing information associated with an operation of Companion Computer system and/or CPU 401. For example, ROM 405 may include a memory device configured to access and store information associated with Companion Computer system, including information for identifying, initializing, and monitoring the operation of one or more components and subsystems of Companion Computer system. RAM 406 may include a memory device for storing data associated with one or more operations of CPU 401. For example, ROM 405 may load instructions into RAM 406 for execution by CPU 401.

Storage 407 may include any type of mass storage device configured to store information that CPU 401 may need to perform processes consistent with the disclosed embodiments. For example, storage 407 may include one or more magnetic and/or Radio Frequency disk devices, such as hard drives, CD-ROMs, DVD-ROMs, or any other type of mass media device. Storage 407 may include flash memory mass media storage or other semiconductor-based storage medium. Alternatively, or additionally, storage 407 may include internet-based cloud storage or access to private web server.

Database 402 may include one or more software and/or hardware components that cooperate to store, organize, sort, filter, and/or arrange data used by Companion Computer system and/or CPU 401. For example, database 402 may include historical data such as, for example, stored PLB route data that is used for route estimation. CPU 401 may also analyze current and previous path parameters to identify trends in historical data. These trends may then be recorded and analyzed to allow the airborne device pack to more effectively navigate. It is contemplated that database 402 may store additional and/or different information than that listed above.

I/O devices 404 may include one or more components configured to communicate information with a user associated with system. For example, I/O devices may include a console with an integrated keyboard and mouse to allow a user to input parameters associated with Companion Computer system. I/O devices 404 may also include a display including a graphical user interface (GUI). I/O devices 404 may also include peripheral devices such as, for example, a printer for printing information associated with Companion Computer system, a user-accessible disk drive (e.g., a USB port, a floppy, CD-ROM, or DVD-ROM drive, etc.) to allow a user to input data stored on a portable media device, a microphone, a speaker system, or any other suitable type of interface device. According to one embodiment, I/O devices 404 may be communicatively coupled to one or more cameras 415 and range finding devices in order to assist in locating target, and/or detect Radio Frequency information transmitted by PLB associated with target.

Interface 403 may include one or more components configured to transmit and receive data via a communication network, such as the Internet, a local area network, a workstation peer-to-peer network, a direct link network, a wireless network, or any other suitable communication platform. For example, interface 403 may include one or more modulators, demodulators, multiplexers, de-multiplexers, network communication devices, wireless devices, antennas, modems, and any other type of device configured to enable data communication via a communication network. According to one embodiment, interface 403 may be coupled to or include wireless communication devices, such as a module or modules configured to transmit information wirelessly using Wi-Fi or Bluetooth wireless protocols. Alternatively, or additionally, interface 403 may be configured for coupling to one or more peripheral communication devices, such as an LTE Cellular modem, or satellite modem.

Systems and methods consistent with the disclosed embodiments are directed to solutions for tracking of a target object (whether moving or stationary) by a robot or an unmanned aerial vehicle (UAS). More particularly, the processes and features disclosed herein provide a solution for allowing the UAS to accurately and reliably follow a target device, while maintaining a hover or predetermined distance from the target device. Exemplary features associated with the presently disclosed system include schemes for adjusting the flight path of the UAS during tracking of the target. One or more Radio Frequency devices mounted on the airborne device pack are used for tracking of the target, as well as cameras that record video of the target for various uses, such as security; intelligence, surveillance, and reconnaissance (ISR) activities, aerial search and recovery, and recreational use, all autonomously, without requiring specific user piloting activities.

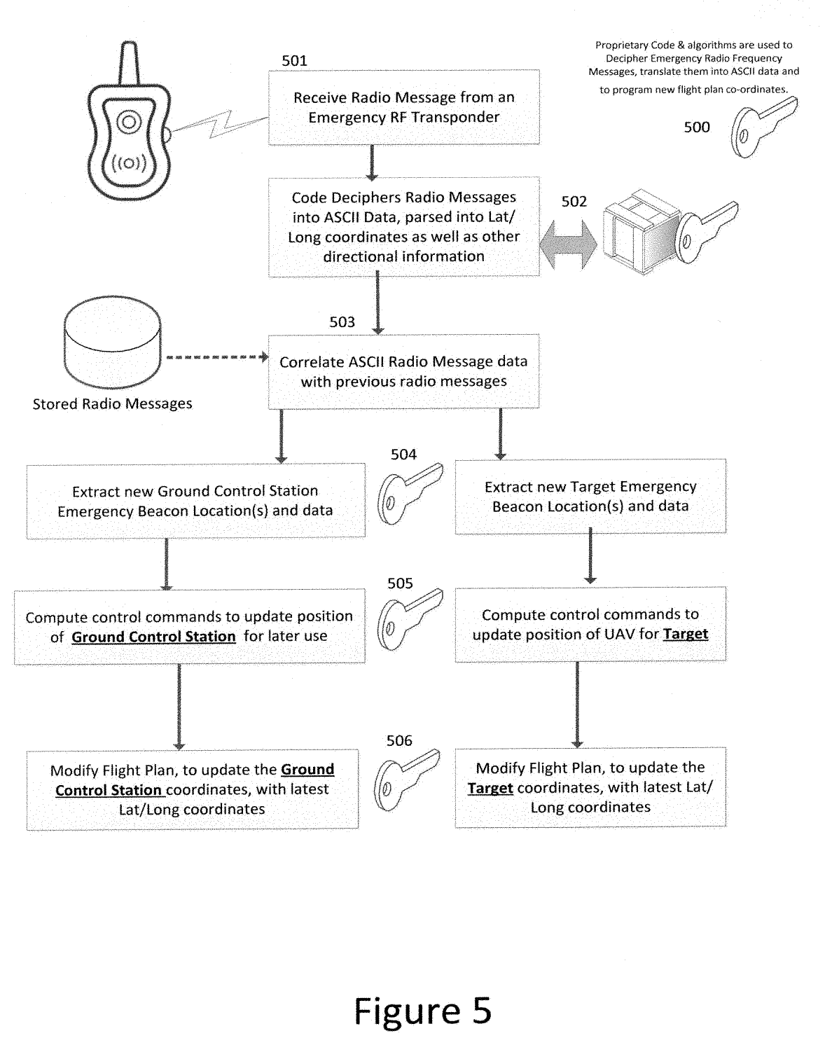

FIG. 5 provides a flowchart depicting an exemplary process 500 to be performed by one or more processing devices associated with a system for navigating an unmanned aerial vehicle relative to a moving target, in accordance with certain disclosed embodiments. The system receives radio message from an Emergency RF Transponder 501, code deciphers radio messages into ASCII Data, parsed into latitude and longitude coordinates as well as other directional information 502. Correlates ASCII radio messages data with previous radio messages 503 and stores them in the cloud. 503 extracts new Ground Control Station Emergency Beacon Location(s) and data. Extracts new Target Emergency Beacon Location(s) and data, 504 computes control commands to update position and Ground Control Station for later use. Compute control commands to update position of UAV for Target, 505 modifies flight plan, to update the Ground Control Station coordinates, with latest latitude and longitude coordinates. Modifies flight plan, to update the Target coordinates, with latest latitude and longitude coordinates. 506 This is the proprietary code used to decipher emergency RF radio frequency messages, then translating them from ASCII data into a readable format and injecting the new flight plan coordinates into the flight controller or flight brain.

The position of the UAS may then be adjusted to maintain the desired relative position and/or distance between the UAS and the target. As explained, a processor associated with the Robot or airborne vehicle may be configured to control a motor or actuator associated with the Robot or airborne vehicle in order to make modifications to the position of the UAS relative to changes in the position of the Robot or airborne vehicle and/or target.

While this specification contains many specific implementation details, these should not be construed as limitations on the claims. Certain features that are described in this specification in the context of separate implementations may also be implemented in combination in a single implementation. Conversely, various features that are described in the context of a single implementation may also be implemented in multiple implementations separately or in any suitable sub combination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

It will be apparent to those skilled in the art that various modifications and variations can be made to the disclosed systems and methods for effectively and accurately using Emergency Band Radio Frequency communication to navigate an unmanned aerial vehicle relative to a moving target. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

### INDUSTRIAL APPLICABILITY

By integrating the presently disclosed relative navigation system into an existing robot or airborne device pack, any robot or small UAS can be transformed into a First Responder UAS that autonomously assists professionals or vehicles in real-time through its onboard payload. In certain scenarios the VHF Radio Signals, and raw video feed, may need to be distilled into actionable data for the user, similar to military systems available today. It is contemplated that Emergency Radio Frequency Data processing can be used to interact with a commercially available onboard video system to extract features of interest (e.g. objects in danger) and may be used to automatically alert the user during the performance of a mission (police patrol or pursuit, search- and rescue operation, etc.). In addition to being downlinked to a centralized ground control station, the video and data feeds from the UAS can be streamed directly to a cloud computing solution, enabling online multi-agency collaboration.

Furthermore, the said invention is a collaborative relationship facilitated by the bidirectional communication between the UASTrakker systems that are mounted on the UAS and the target device mounted on the target, which ensures that the UAS has access to both initial configuration and real-time information about its Operator, including any new location data. This enables the presently disclosed system to be robust to aggressive relative motion and to environmental disturbances, making it ideally suited to emergency responders and other applications involving location and tracking, (Farming, military, etc.). For example, sensor data obtained by the airborne device pack from the target device may be used to (1) locate an asset or person in danger, with high-accuracy and low-latency, (2) increase response time in the SAR UAS navigation and machine operation, (3) provide robustness to varying environmental conditions, and/or (4) provide a method of landing the UAS on a moving platform, such as a ship.

By exploiting the collaborative and Emergency Tracking nature of this application, our system provides medium sized UASs with the accuracy and bandwidth necessary to accelerate Emergency situational awareness, while (1) being robust to aggressive environmental disturbances and (2) improving operational success. Key benefits of our approach compared to current state-of-the-art methods include: (1) designed for Rescue Missions or Asset monitoring applications with robustness to locating a VHF Emergency Personal Locator Beacon or similar; (2) designed for the real-world with robustness to varying environmental conditions, robustness to poor ambient magnetic environment (typical of low-altitude or indoor flight), and; (3) high-accuracy, high bandwidth navigation information that allows for tight UAS flight control laws; (4) high-availability of the navigation solution.

### Glossary of Terms and Acronyms

AIS—Automatic Identification System
CPU—Central Processing Unit
EPIRB—Emergency Position Indicating Radio Beacon
ESC—Electronic Speed Controller
GCS—Ground Control Station
GPS—Global Positioning Sattelite
IMU—Inertial Measurement Unit
I/O Device—Input and/or Output Device
ISR—Intelligence, Surveillance and Reconnaissance
PLB—Personal Locator Beacon
RAM—Random Access Memory
RC—Radio Controlled
RF—Radio Frequency
ROM—Read Only Memory
SAR—Search And Rescue
UAS—Unmanned Aerial System
VHF—Very High Frequency Radio Waves

What is claimed is:

1. A method for navigating a robotic or airborne vehicle, hereinafter referred to as an airborne vehicle, relative to a moving target and/or Ground Control Station, (Hereinafter referred to as GCS), comprising: detecting, at a signal detector associated with the airborne vehicle, a signal generated by a signal emitter associated with the target and/or GCS; correlating, by a Companion Computer and/or processor associated with the airborne vehicle, the detected signal with a previously-detected signal; determining, by the Companion Computer and/or processor based on the correlating, a change in location of the target and GCS; adjusting a position of the airborne vehicle based, at least in part, on the determined change in location in order to cause the airborne vehicle to follow a flight path and locate an Emergency Radio Frequency Locator Beacon that is in radio range. Our system uses a Transponder that detects one of the VHF frequencies typically used for Military or Civilian Navigation, and in particular Emergency Location Communication; such as a PLB, EPIRB, or device used for maritime rescue, .such as AIS (121.5 MHz) “Man Overboard Beacon”, then maintains a Hover or predetermined distance between the airborne vehicle and the target; and causing the airborne vehicle to monitor the path traversed by the target; and to provide situational awareness over traditional UAS communication channels, as well as over modem communication, and to provide an up-to-date co-ordinate for the GCS for landing purposes.

2. The method of claim 1, wherein adjusting the position of the airborne vehicle includes adjusting the position of the airborne vehicle to locate a Personal Locator Beacon, Man-Over-Board Device, AIS, EPIRB or Military Asset Radio Frequency device, using the respective Radio Frequency, (e.g 121.5 MHz for AIS).

3. The method of claim 1, where the airborne vehicle incorporates an onboard companion computer, (Hereinafter referred to as “Companion Computer” and/or “UASTrakker System”), for onboard Flight control Algorithms to be deployed.

4. The method of claim 1, where the airborne vehicle incorporates a modem device (such as LTE or Satellite), for 2 way communications, and data delivery to any cloud solution that is deployed.

5. The method of claim 1, where the airborne vehicle incorporates an Emergency Radio or transceiver that detects one of the VHF frequencies typically used for Military or Civilian Navigation, and in particular Emergency Location Communication; such as a PLB, EPIRB, or Man Overboard device used for maritime rescue.

6. The method of claim 1, further comprising receiving, at the processor associated with the airborne vehicle from at least one sensor located on-board the target, information indicative of at least one of a position including latitude and longitude, a rotation, an orientation, an acceleration, a velocity, or an altitude associated with the target.

7. The method of claim 1, wherein further comprising receiving, at the processor associated with the airborne vehicle from at least one sensor located on the Ground Control Station, information indicative of at least one of a position including latitude and longitude, a rotation, an orientation, an acceleration, a velocity, or an altitude associated with the Ground Control Station.

8. The method of claim 1, wherein receiving the information includes receiving orientation information from at least one orientation sensor located onboard the target.

9. The method of claim 5, further comprising: predicting, by the companion computer associated with the airborne vehicle based on the received information, a movement of the target; and wherein adjusting the position of the airborne vehicle is further based, at least in part, on the movement of the target.

10. The method of claim 1, wherein receiving the information includes receiving directional information from at least one magnetometer located on-board the target.

11. The method of claim 1, wherein receiving the information includes receiving GPS coordinates and velocities from at least one GPS module located onboard the target.

12. The method of claim 1, wherein the signal emitter includes a Personal Locator Beacon (PLB) or similar Emergency RF Band Radio, and the method further includes detecting a Radio Frequency signal for each of the Radio Frequency signals generated by a respective one of the PLB type devices.

13. The method of claim 12, further comprising comparing a pattern defined by the detected Emergency Radio Frequency signals with a previously-detected pattern.

14. The method of claim 13, wherein determining the change in location is based on the comparison between the pattern defined by the detected Emergency Radio Frequency signals with the previously-detected pattern.

15. The method of claim 1, further comprising: determining that if the target is not detected; it will responsively revert the flight path of the airborne vehicle to cause the airborne vehicle to follow an otherwise predetermined flight plan.

16. A system for aerial monitoring of a target, comprising: a target RF device coupled to the target, the target RF device comprising: at least one standard Emergency Radio Frequency Transmitter or Transponder configured to generate an Emergency Radio Frequency signal; an airborne device coupled to an airborne vehicle and in data communication with the target device, the airborne device comprising: a modem, an Emergency Radio Frequency detector configured to detect the Emergency Radio Frequency signal generated by the target device; a companion computer and processor communicatively coupled to the modem and Radio Frequency detector, and configured to: compare the detected Radio Frequency signal with a previously-detected Radio Frequency signal; determine a change in location the target; generate a control signal for adjusting a position of the airborne vehicle based, at least in part, on the determined change in location in order to cause the airborne vehicle to follow a flight path that maintains a Hover or predetermined distance between the airborne vehicle and the target; responsively adjust the flight path of the airborne vehicle to cause the airborne vehicle to monitor the path traversed by the target; and provide situational awareness.

17. The system of claim 16, wherein the at least one Radio Frequency Transponder which is configured to generate a respective Radio Frequency signal.

18. The system of claim 17, wherein the processor is further configured to compare a pattern defined by a detected Radio Frequency signals from the previously-detected pattern.

19. The system of claim 18, wherein the processor is further configured to detect other Emergency Radio Frequency responders in the area, and relay the co-ordinates of other active beacons detected to the GCS over Modem communication.

20. An aerial vehicle, comprising: a signal detector; and a control system comprising a processor, the control system configured to: receive, from the signal detector, a signal generated by a signal emitter associated with a target; correlate the detected signal with a previously-detected signal; determine, based on the correlating, a change in location of the target; adjust a position of the aerial vehicle based on the determined change in location in order to cause the aerial vehicle to follow a flight path that maintains a hover or predetermined distance between the aerial vehicle and the target;
